(19) United States
(12) Patent Application Publication
(10) Pub. No.: US 2026/0218794 A1
(43) Pub. Date: Jul. 30, 2026

(54) MECHANICAL SEAL ARRANGEMENT

(71) Applicant: EagleBurgmann Germany GmbH & Co. KG, Wolfratshausen (DE)

(72) Inventors: Michael Müller, Bichl (DE); Dieter Klusch, Bad Tolz (DE)

(73) Assignee: EagleBurgmann Germany GmbH & Co. KG, Wolfratshausen (DE)

(21) Appl. No.: 19/149,672

(22) PCT Filed: Dec. 11, 2023
(86) PCT No.: PCT/EP2023/085109

§ 371 Date: Jul. 21, 2025

(30) Foreign Application Priority Data
Feb. 13, 2023 (DE) 10 2023 103 419.7

(51) Int. Cl. F16J 15/34

(52) U.S. Cl. CPC F16J 15/3492

(57) ABSTRACT

The invention relates to a mechanical seal arrangement, comprising a mechanical seal (2) having a rotating slide ring (3) having a first sliding surface, and a stationary slide ring (4) having a second sliding surface, which define a sealing gap (5) between the sliding surfaces, a wired unit (7), which is arranged on one of the slide rings, wherein the wired unit (7) comprises a cable (71) which is configured for supplying with electrical energy and/or for transmitting information, and a protective pin (6) which is configured for providing protection for the cable (71), wherein the protective pin (6) comprises a recess (8) through which the cable (71) supplied from the slide ring provided with the wired unit is guided.

The present invention relates to a mechanical seal arrangement comprising a wired unit, for example a sensor, which is arranged in a slide ring and is connected by means of a cable for power supply and/or for information exchange.

Mechanical seal arrangements are known in various embodiments from the prior art. Recently, attempts are increasingly being made to obtain information relating to the state of a mechanical seal, in particular at the sliding surfaces of the mechanical seal. In this case, wired units, such as sensors, are arranged on an outer periphery or also in recesses in the slide ring. In this case, the cables connected to the wired units must be guided away from the slide ring and are often exposed to external extreme conditions with respect to temperature, pressure or medium. Such cables must also be able to compensate follow-up movements of the slide rings, in particular in the axial direction. In this case, cable breakage often occurs, such that there is no longer a connection to the wired unit.

The object of the present invention is therefore that of providing a mechanical seal arrangement comprising a wired unit, which allows for reliable cable contacting of a unit arranged in or on the slide ring, with a simple design and simple, cost-effective producibility.

This object is achieved by a mechanical seal arrangement having the features of claim 1. The dependent claims disclose preferred developments of the invention.

The mechanical seal arrangement according to the invention having the features of claim 1 has the advantage, compared with this, that a wired unit, for example a sensor or the like, which is contacted via a cable, can be arranged in an optimal position on or in a slide ring. In this case, the cable can be reliably guided to a stationary component, for example a housing component, without risk of damage during operation. This is achieved according to the invention in that the mechanical seal arrangement comprises a mechanical seal having a rotating and a stationary slide ring which define a sealing gap between their sliding surfaces. The wired unit is arranged in or on one of the slide rings. The cable, which is connected to the wired unit, is configured for power supply and/or information supply of the wired unit. A protective pin ensures protection of the cable. The protective pin is arranged on the slide ring comprising the wired unit, and is configured for providing protection for the cable, wherein the protective pin comprises a recess through which the cable supplied from the slide ring is guided. Thus, the supplied cable can be reliably guided away from the slide ring, without the risk of damage to the cable during operation of the mechanical seal arrangement. In order to prevent damage by kinking of the cable, said cable is preferably guided away from the slide ring in an arcuate manner.

Particularly preferably, the wired unit is arranged on the stationary slide ring. In this case, the protective pin is arranged between the stationary slide ring and the stationary component, in particular a housing component or the like. The protective pin thus provides a connection between the stationary slide ring and the stationary component, and protects the cable proceeding from the stationary slide ring to the stationary component.

The cable supplied from the stationary slide ring is preferably introduced from the stationary slide ring directly into the recess in the protective pin. The cable is preferably arranged and protected entirely in the recess of the protective pin, proceeding from the stationary slide ring as far as the stationary component.

Further preferably, the slide ring comprising the wired unit comprises a groove on an outer periphery. In this case, the protective pin is arranged in the groove. The groove preferably extends in the axial direction, further preferably the groove extend entirely in the axial direction through the slide ring.

A particularly compact and robust structure is ensured if the protective pin preferably comprises a slot region and the recess comprises a slot in the slot region. In this case, the cable can be supplied from the slide ring, preferably directly, into the slot, and is thus protected by the walls surrounding the slot

Particularly preferably, the slot is open on one side in the axial direction and is configured as a radial continuous slot, such that the protective pin comprises a first and a second free arm, between which the slot is formed. Thus, a standardized protective pin can be used in a plurality of different designs of mechanical seals.

The protective pin preferably comprises a head region which adjoins the slot region. The recess comprises a through-opening in the head region, which is arranged in the head region in such a way that the slot of the slot region is arranged at one end of the through-opening, in the head region. The slot thus transitions directly into the through-opening. As a result, the cable can be easily introduced from the slot into the through-opening, without the risk of damage.

Further preferably, the slide ring comprising the wired unit is axially movable, in particular by providing a pretension element, the preload force of which acts on the axially movable slide ring. As a result, the axially movable slide ring can also be provided with a wired unit, and in particular monitoring of the axially movable slide ring, for example by means of a wired sensor, can be possible. Despite the axial movements of the slide ring, no damage occurs on the cable owing to the provision of the protective pin. As a result, the axially movable slide ring comprising the wired unit can also be monitored over its entire service life, for example by means of a sensor.

Further preferably, a plurality of cables is supplied from the slide ring to the stationary component through a common recess of the protective pin. Thus, despite providing a plurality of wired units on a slide ring, only one single, common protective pin must be provided in order to guide all the cables of the wired units of the slide ring to the housing.

A particularly good protective effect of the protective pin is achieved if the cable supplied from the slide ring is guided exclusively in the slot of the protective pin. As a result, particularly good shielding of the protective pin can be made possible, wherein it is in particular also possible for the protective pin to be arranged in the medium to be sealed, which can for example be at high temperatures and/or a high pressure.

Particularly preferably, the wired unit is arranged in a blind hole in the slide ring, wherein the blind hole is arranged at an acute angle, in particular approx. 10° to 40°, more particularly approx. 20°, relative to the sealing gap. Thus, the cable of the wired unit is guided relatively steeply out of the slide ring and, without a protective pin, is at high risk of kinking or other damage. In this case, the protective pin also protects the cable that is guided out of the slide ring at an acute angle.

Further preferably, the protective pin is furthermore configured for also transmitting a torque from or to the slide ring comprising the wired unit and another component. Thus, the protective pin can also assume a function of torque transmission between the slide ring and another component, in addition to protecting the cable. Preferably, in this case, a protective pin of this kind comprises a cap on the slot region of the protective pin, via which the torque is introduced into the protective pin.

The cable of the wired unit is preferably a power cable and/or an information cable.

The wired unit is further preferably a sensor, which is arranged on or in the slide ring. Particularly preferably, in this case, the sensor is arranged in the slide ring, in particular in a blind hole. The sensor is preferably a temperature sensor and arranged in the slide ring, such that a particularly accurate temperature acquisition of the slide ring is possible.

Further preferably, the protective pin is configured such that the slot region is larger, in the axial direction, than the head region of the protective pin. The slot region further preferably is in particular more than ⅔ of a total length of the protective pin in the axial direction.

Embodiments of the invention are described in detail in the following, with reference to the accompanying drawings, in which:

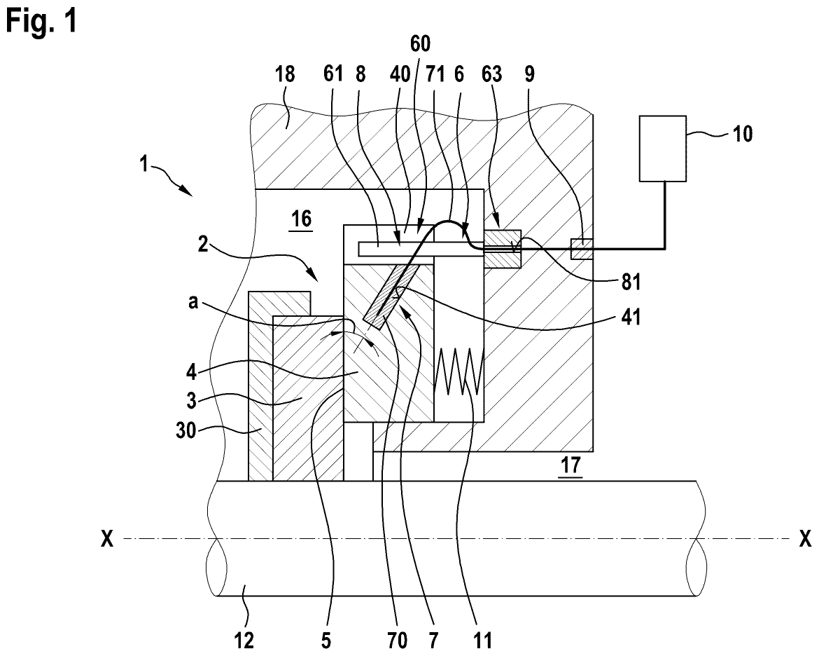

FIG. 1 is a schematic sectional view of a mechanical seal arrangement according to a first embodiment of the invention,

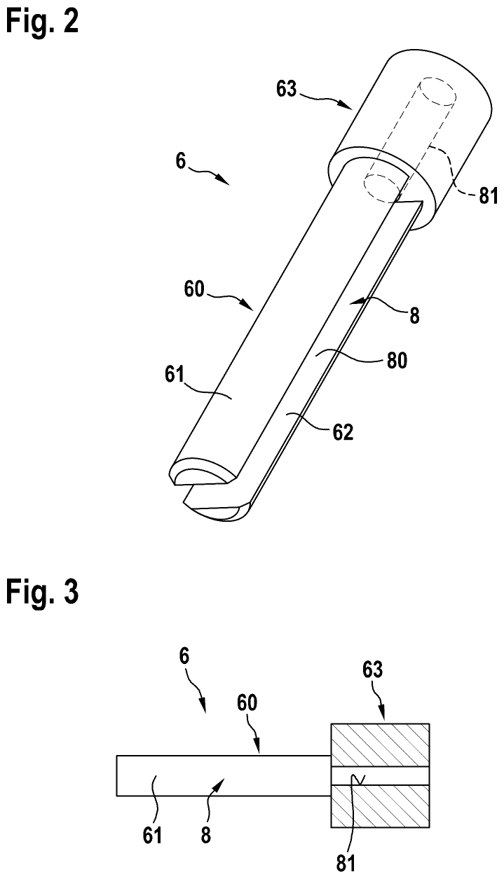

FIG. 2 is a schematic perspective view of a protective pin of the mechanical seal arrangement of FIG. 1,

FIG. 3 is a schematic sectional view along a longitudinal axis of the protective pin of FIG. 2,

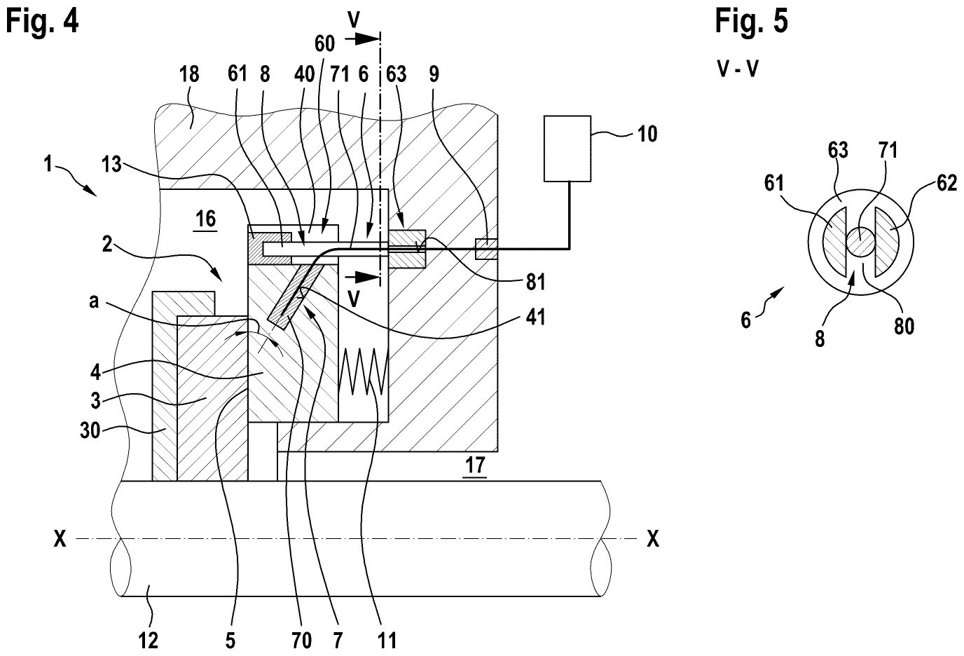

FIG. 4 is a schematic sectional view of a mechanical seal arrangement according to a second embodiment of the invention, and

FIG. 5 is a schematic sectional view along the line V-V of FIG. 4.

A mechanical seal arrangement 1 according to a first preferred embodiment of the invention is described in detail in the following with reference to FIGS. 1 to 3.

In this case, the mechanical seal arrangement 1 seals a product region 16, which comprises a medium to be sealed, from an atmosphere region 17, at a shaft 12.

The mechanical seal arrangement 1 comprises a mechanical seal 2 having a rotating slide ring 3 and a stationary slide ring 4. A sealing gap 5 is defined between the sliding surfaces of the slide rings 3, 4, in a known manner.

The rotating slide ring 3 is connected to the shaft 12 by means of a slide ring carrier 30 and rotates together with said shaft.

The stationary slide ring 4 is arranged on a stationary component 18, which is a housing. In this case, the stationary slide ring 4 is provided so as to be axially movable, and is preloaded by means of a pretension element 11 in an axial direction X-X against the rotating slide ring 3. As can furthermore be seen from FIG. 1, a wired unit 7 is arranged in the stationary slide ring 4. The wired unit 7 comprises a sensor 70 and a cable 71. The cable 71 connects the sensor 70 to a measuring unit 10.

In this embodiment, the sensor 70 is a temperature sensor, which is configured for measuring a temperature of the stationary slide ring during operation. In this case, the cable 71 is configured for transmitting both electrical energy and information, in particular measured values, between the sensor 70 and the measuring unit 10.

The sensor 70 is arranged in a blind hole 41, at an acute angle a relative to the sealing gap 5. In this case, the cable 70 is guided at said acute angle a out of a radially outwardly directed side of the stationary slide ring.

The mechanical seal arrangement 1 further comprises a protective pin 6, which is visible in detail from FIGS. 2 and 3. The protective pin 6 comprises a slot region 60 and a head region 63. As can be seen in particular from FIG. 1, the slot region 60 is arranged in a groove 40 in the stationary slide ring 4. The groove 40 is a continuous groove extending in the axial direction X-X on the outer periphery of the stationary slide ring 4. In this case, a width of the groove 40 is selected such that the slot region 60 can be arranged without problem in the groove 40 (cf. FIG. 1).

The head region 63 has a slightly larger diameter than the slot region 60. The head region 63 is arranged in the stationary component 18 and is fixed there, e.g. by means of a press-fit.

The slot region 60 comprises a first arm 61 and a second arm 62, as well as a recess 8. In this case, the recess 8 comprises a slot 80 which is formed between the first and second arm 61, 62, and a through-opening 81 provided in the head region 63.

The slot 80 is formed between the arms 61, 62 as a slot that is fully continuous in the radial direction. In this case, the slot extends through from the head region 63 as far as a free end of the slot region 60 and is open at the free end (cf. FIG. 2). Thus, the two arms 61, 62 extend in parallel and are merely fixed at the head region 63 and are otherwise not interconnected in any way.

As can be seen from FIG. 1, the cable 71 is guided out of the stationary slide ring 4 in the region of the groove 40 and is introduced directly into the recess 8, more precisely into the slot 80. The cable 71 is then guided in an arc, first radially outwardly out of the slot 80 and then before the through-opening 81 back into the slot 80. The cable 71 is then guided through the through-opening 81 into the housing, and from there to the measuring unit 10.

Furthermore, a seal 9 is also arranged in the housing 10, in order to seal the cable, guided through the through-opening 81, from the product region 16.

As can be seen from FIG. 1, in this case the cable 71 is thus guided, proceeding from the stationary slide ring 4, first through the product region 16, until it is then introduced into the stationary component 18. Thus, the cable is exposed to the conditions of the medium to be sealed, in particular possibly high temperatures and high pressures. Furthermore, the stationary slide ring 4, which comprises the wired unit 7, is arranged so as to be axially movable. In this case, the cable 71 can follow axial movements, in particular owing to the cable 71 that is guided out of the stationary slide ring 4 in an arcuate manner, without problem and in particular without damage.

Thus, in particular the cable 71 of the wired unit 7 is protected by the protective pin 6 and reliably guided to the stationary component 18 and then through this to the measuring unit 10. Thus, an optimal arrangement of the wired unit 7 in a slide ring can be made possible, wherein in particular the cable 71 can also be guided out of the slide ring at a radial outer side thereof. This makes it possible for the cable to be guided out in a soft arc, such that axial follow-up movements of the slide ring can also be performed without damage to the cable.

FIGS. 4 and 5 show a mechanical seal arrangement 1 according to a second embodiment of the invention. Identical or functionally identical parts are denoted as in the first embodiment.

The second embodiment substantially corresponds to the first embodiment, wherein in contrast with the first embodiment in the case of the second embodiment the cable 71 of the wired unit 7 is guided out of the stationary slide ring 4 in such a way that the cable 71 is arranged entirely in the slot 80 between the two arms 61, 62. As a result, the cable 71 is guided in the through-opening 81 in the head region 63 of the protective pin 6 in a straight line. As is clear from FIG. 5, in this case the cable 71 is guided, in the slot region 60, entirely between the two arms 61, 62. In order to be able to follow larger axial movements of the stationary slide ring 4, which is preloaded against the rotating slide ring 3 by means of the pretension element 11, the cable 71 can for example be guided in a wave-like manner in the slot region 60, without protruding radially outwards or radially inwards beyond the arms 61, 62. Thus, the cable 71 is protected particularly well from external influences, in particular from the product region 16, and can nonetheless follow axial movements.

The protective pin 6 of the second embodiment additionally also has a torque transmission function. In this case, during operation of the stationary slide ring 4 torque is transmitted to the stationary component 18 via the protective pin 6, configured as an additional torque transmission element. In this case, the protective pin 6 additionally also comprises a cap 13 which is directly in contact with the walls of the groove 40 on the radial outer periphery of the stationary slide ring 4. Thus, in addition to the function of protecting the cable 71, the protective pin also has a torque-transmitting function. Otherwise, the second embodiment corresponds to the first embodiment, and therefore reference can be made to the description given there.

### LIST OF REFERENCE SIGNS

1 mechanical seal arrangement
2 mechanical seal
3 rotating slide ring
4 stationary slide ring
5 sealing gap
6 protective pin
7 wired unit
8 recess
9 seal
10 measuring unit
11 pretension element
12 shaft
13 cap
16 product region
17 atmosphere region
18 stationary component/housing
30 slide ring carrier
40 groove
41 blind hole
60 slot region
61 first arm
62 second arm
63 head region
70 sensor
71 cable
80 slot
81 through-opening
a acute angle
X-X axial direction

1. Mechanical seal arrangement, comprising:
a mechanical seal having a rotating slide ring having a first sliding surface and a stationary slide ring having a second sliding surface, which define a sealing gap between the sliding surfaces,
a wired unit which is arranged on one of the slide rings,
wherein the wired unit comprises a cable which is configured for supplying with electrical energy and/or for transmitting information, and
a protective pin which is arranged on the slide ring comprising the wired unit and is configured for providing protection for the cable,
wherein the protective pin comprises a recess through which the cable supplied from the slide ring provided with the wired unit is guided.

2. Mechanical seal arrangement according to claim 1, wherein the wired unit is arranged on the stationary slide ring and the protective pin is arranged between the stationary slide ring and a stationary component.

3. Mechanical seal arrangement according to claim 1, wherein the cable is supplied from the slide ring comprising the wired unit and is introduced directly into the recess in the protective pin.

4. Mechanical seal arrangement according to claim 1, wherein the slide ring comprising the wired unit comprises a groove on an outer periphery, in which groove the protective pin is arranged.

5. Mechanical seal arrangement according to claim 1, wherein the protective pin comprises a slot region and a head region, wherein the recess comprises a slot in the slot region.

6. Mechanical seal arrangement according to claim 5, wherein the slot is open on one side in the axial direction and is configured as a radial continuous slot, such that the slot region comprises a first arm and a second arm, between which the slot is formed.

7. Mechanical seal arrangement according to claim 5, wherein the recess comprises a through-opening in the head region of the protective pin, such that the slot transitions directly into the through-opening and the cable is guided through the through-opening.

8. Mechanical seal arrangement according to claim 1, wherein the protective pin is fixed in the stationary component.

9. Mechanical seal arrangement according to claim 1, wherein the slide ring comprising the wired unit is preloaded in the axial direction by means of a pretension element and is arranged so as to be movable in the axial direction.

10. Mechanical seal arrangement according to claim 1, wherein the wired unit comprises a sensor which is arranged on or in the slide ring.

11. Mechanical seal arrangement according to claim 5, wherein the cable is guided out of the slide ring comprising the wired unit, exclusively in the slot of the protective pin, as far as the stationary component.

12. Mechanical seal arrangement according to claim 1, wherein the cable is guided out of the slide ring comprising the wired unit at a radial outer side of the slide ring at an acute angle relative to the sealing gap.

13. Mechanical seal arrangement according to claim 1, wherein the protective pin is furthermore configured for transmitting a torque from or to the slide ring comprising the wired unit.
